(19) United States
(12) Patent Application Publication
(10) Pub. No.: US 2024/0369473 A1
(43) Pub. Date: Nov. 7, 2024

(54) ANGLE-RESOLVED SPECTROSCOPIC ELLIPSOMETER USING SPATIAL LIGHT MODULATOR AND THICKNESS MEASURING METHOD FOR THIN FILM

(71) Applicant: SEOUL NATIONAL UNIVERSITY R&DB FOUNDATION, Seoul (KR)

(72) Inventors: Heui Jae PAHK, Seoul (KR); Min Gyu KIM, Cheongju-si (KR)

(21) Appl. No.: 18/643,796

(22) Filed: Apr. 23, 2024

(30) Foreign Application Priority Data
May 3, 2023 (KR) 10-2023-0057766

(51) Int. Cl. G01N 21/21; G01B 11/06

(52) U.S. Cl. CPC G01N 21/211; G01B 11/0641; G01N 2021/213

(57) ABSTRACT

Provided are an angle-resolved spectroscopic ellipsometer and a method of measuring thickness of a thin film. The ellipsometer includes: a spatial light modulator spatially modulating light to a back focal plane of an objective lens; an incident light controller controlling the light emitted from the spatial light modulator to form a ring-shaped image and controlling the amount of light to have a sinusoidal distribution along the circumference of a ring; a polarizer polarizing the light from the modulator; a first beam splitter changing the direction of the light; the objective lens allowing the light to incident on the sample; an analyzer analyzing the polarization of the light from the sample; a camera capturing an image; a spectrometer receiving a signal of light; a second beam splitter; and a signal processing computer calculating a physical property value of a thin film by processing the signal.

### CROSS-REFERENCE TO RELATED APPLICATION

This application claims the benefit of Korean Patent Application No. 10-2023-0057766, filed on May 3, 2023, in the Korean Intellectual Property Office, the disclosure of which is incorporated herein in its entirety by reference.

### BACKGROUND

### 1. Field

The present invention relates to an ellipsometry system and a thin film thickness measuring method capable of measuring the thickness and physical properties of a thin film.

### 2. Description of the Related Art

Ellipsometry is a method of measuring the physical properties of a sample by using a change in polarization characteristics of light. Measuring equipment that uses ellipsometry is called an ellipsometer. The ellipsometer polarizes incident light into a desired shape to be incident on a sample, and measures a polarization state of light reflected (in a reflective ellipsometer) or transmitted (in a transmissive ellipsometer) from or through the sample to measure physical properties such as a complex refractive index, a dielectric function, electrical conductivity, and a crystal state such as a lattice structure.

For example, a reflective ellipsometer may be used to measure the thickness of a multi-layer thin film, and is in the spotlight in that it adopts a non-contact non-destructive method compared to other types of thin film thickness measurement methods, and is also applicable to a transparent material or a dielectric thin film, and has excellent resolution, and is widely used in displays and in the semiconductor industry.

However, since general ellipsometers irradiate light only at one point with a constant slope, imaging is difficult due to low lateral resolution, and it is difficult to analyze a desired region in a narrow area or fine pattern. In order to overcome this, a method for imaging a sample is attempted by arranging a charge coupled device (CCD) array or the like used in a camera at an optical sensor end, but there is a limit in increasing lateral resolution due to an inclined structure of the ellipsometer.

Meanwhile, in order to improve this problem, Korean Patent Registration No. 10-2235642 proposed a coaxial polarization ellipsometer. The registered patent contributed to the improvement of the resolution, but did not significantly reduce the measurement time.

An objective of the present invention is to provide an ellipsometer capable of measuring a fine region of 5 μm or less while dramatically shortening the measurement time by improving the structure of a conventional ellipsometer, and a thin film thickness measurement method using the ellipsometer.

### SUMMARY

In order to achieve the above objective, according to the present invention, there is provided an angle-resolved spectroscopic ellipsometer using a spatial light modulator, the angle-resolved spectroscopic ellipsometer including: the spatial light modulator spatially modulating light originating from a light source to be irradiated to a back focal plane of an objective lens;
an incident light controller controlling light emitted from the spatial light modulator to form a ring-shaped image and controlling the amount of light to have a sinusoidal distribution along the circumference of a ring;
a polarizer polarizing the light emitted from the spatial light modulator;
a first beam splitter changing the direction of the light passing through the polarizer and through which the light reflected from the sample passes;
the objective lens allowing the light incident from the first beam splitter to be incident on the sample;
an analyzer analyzing the polarization of the light reflected from the sample;
a camera capturing an image of the back focal plane of the objective lens or a surface of the sample;
a spectrometer receiving a signal of light reflected from a specific region of the surface of the sample;
a second beam splitter reflecting a part of the light reflected from the sample to the spectrometer, and allowing the rest of the light to be incident on the camera; and
a signal processing computer calculating a physical property value of a thin film by post-processing the signal received by the spectrometer.

The ellipsometer may include a first relay lens arranged between the spatial light modulator and the polarizer and adjusting a path of light of the spatial light modulator to form an image at a specific position on the back focal plane of the objective lens.

The ellipsometer may include a second relay lens arranged between the analyzer and the second beam splitter and assisting the camera to observe the image of the sample.

The spectrometer includes an optical fiber light receiving unit, and the spectrometer may be installed to be two-dimensionally movable by a transfer device.

A method of measuring thickness of a thin film using the ellipsometer, the method includes:
a sinusoidal beam incident operation in which the spatial light modulator, by the incident light controller, irradiates light received from a light source into light forming a ring-shaped image and a sinusoidal distribution of the amount of light along the circumference of the ring-shaped image;
a beam projection operation in which the light irradiated in the sinusoidal beam incident operation is polarized through the polarizer and then projected onto a back focal plane of the objective lens;
a reflected light signal acquisition operation in which the light projected in the beam projection operation is reflected from a specific region of a sample by the objective lens, passes through the analyzer, and is detected as an electrical signal by the spectrometer; and
a signal processing operation of calculating physical properties of a thin film by analyzing the signal acquired in the reflected light signal acquisition operation.

The intensity of light emitted in the sinusoidal beam incident operation may have a function ½ distribution.

The intensity of light emitted in the sinusoidal beam incident operation may have a function

$$\frac{1}{2} + \frac{1}{2} cos ( 2 φ )$$

distribution.

The intensity of light emitted in the sinusoidal beam incident operation may have a function

$$\frac{1}{2} + \frac{1}{2} cos ( 4 φ )$$

distribution.

The intensity of light emitted in the sinusoidal beam incident operation may have a function

$$\frac{1}{2} + \frac{1}{2} sin ( 2 φ )$$

distribution.

The intensity of light emitted in the sinusoidal beam incident operation may have a function

$$\frac{1}{2} + \frac{1}{2} sin ( 4 φ )$$

distribution.

In the signal processing operation, a polarization factor of the sample may be obtained by calculating (e.g.: add, subtract, multiply, divide) the intensity of the reflected light measured by the spectrometer under different incident light conditions.

The incident light controller may change the incident angle of light incident onto the sample by changing the radius of the ring-shaped image.

The thickness of the thin film may be obtained by changing the incident angle in the incident light controller, forming a three-dimensional measurement polarized curved surface with a polarization factor, a wavelength value, and an incident angle, which are obtained in the signal processing operation, as orthogonal coordinates, and comparing the three-dimensional measurement polarized curved surface with a three-dimensional theoretical polarized curved surface obtained by calculation.

### BRIEF DESCRIPTION OF THE DRAWINGS

These and/or other aspects will become apparent and more readily appreciated from the following description of the embodiments, taken in conjunction with the accompanying drawings in which:

FIG. 1 is a conceptual diagram showing a basic structure of an ellipsometer according to the conventional art;

FIG. 2 is a configuration diagram of an ellipsometer according to the present invention;

FIGS. 3 and 4 are conceptual views illustrating characteristics of a back focal plane of an objective lens, according to the present invention;

FIGS. 5 and 6 are conceptual views illustrating a relationship between incident light incident on a sample and reflected light reflected from the sample, according to the present invention;

FIG. 7 is a view illustrating exemplary shapes of incident light according to the present invention;

FIG. 8 is a view illustrating a shape in which the radius of incident light is changed, according to the present invention;

FIG. 9 is a graph showing an exemplary image of a measured polarization curved surface, according to the present invention; and

FIG. 10 is a graph showing an exemplary image of a theoretical polarization curved surface, according to the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items Expressions such as “at least one of,” when preceding a list of elements, modify the entire list of elements and do not modify the individual elements of the list.

The present invention may have various changes and may have various forms, and embodiments of the present invention will be described in detail herein. However, the present invention is not intended to be limited to the specific disclosure, and it should be understood that the present invention includes all changes, equivalents, and replacements included in the spirit and technical scope of the present invention.

The terms are used for the purpose of distinguishing one component from another. The terms used in the present application are used to describe specific embodiments only, and are not intended to limit the present invention. Singular expressions include plural expressions unless they have a distinctly different meaning in the context.

In the present invention, terms such as “comprises,” “has,” or “consists of” are intended to refer to the presence of features, numbers, steps, operations, components, parts, or combinations thereof described in the specification, but it should be understood that the terms do not preclude the existence or addition of one or more other features, numbers, steps, operations, components, parts, or combinations thereof.

Unless otherwise defined, all terms used herein, including technical or scientific terms, have the same meaning as commonly understood by one of ordinary skill in the art to which the present invention pertains. Such terms as those defined in commonly used dictionaries should be interpreted as having a meaning that is consistent with their meaning in the context of the relevant art, and are not to be interpreted in an idealized or overly formal sense unless expressly so defined herein.

Hereinafter, a preferred embodiment of the present invention will be described in more detail with reference to the accompanying drawings.

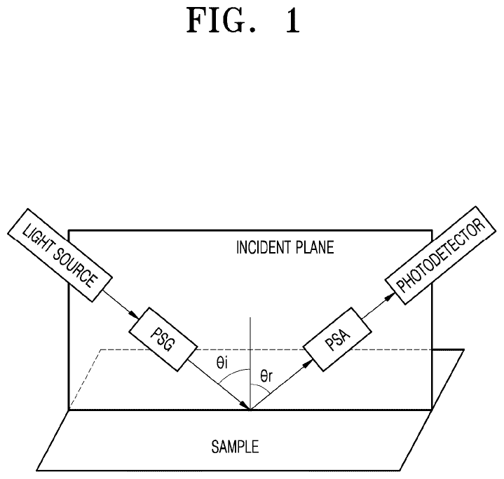

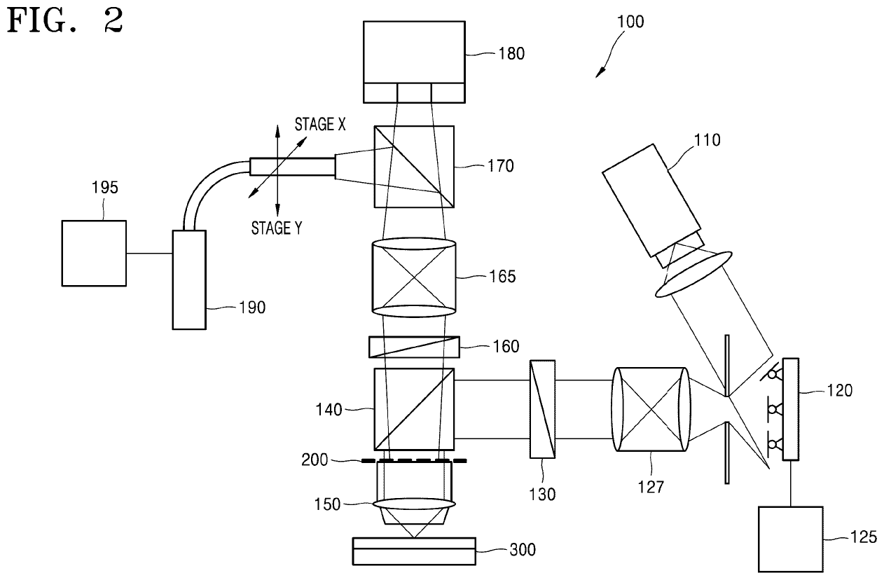

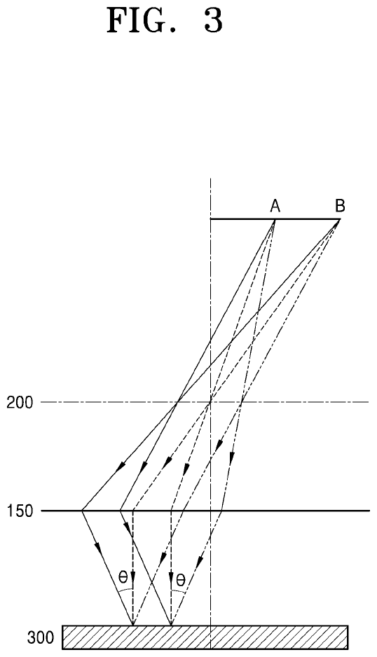

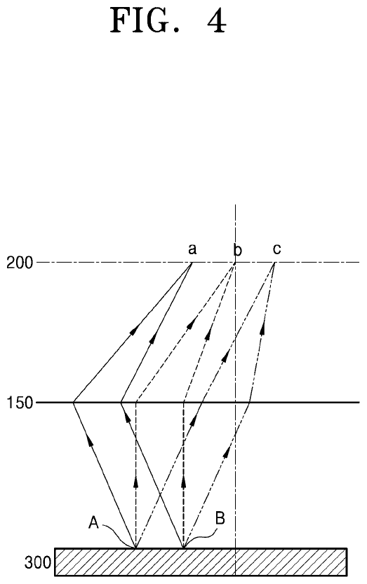

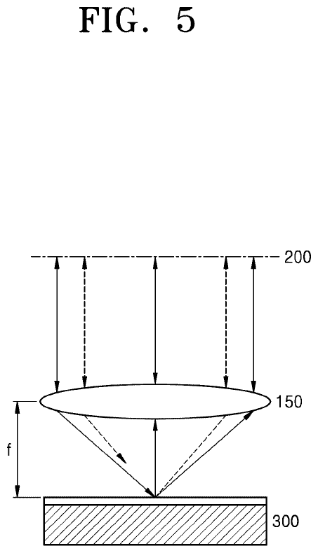

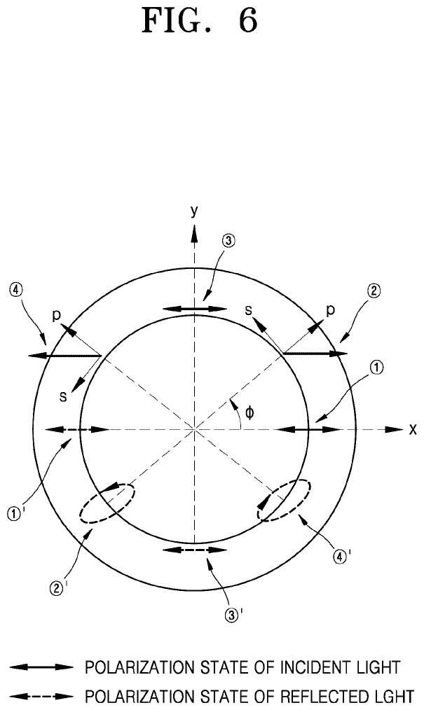

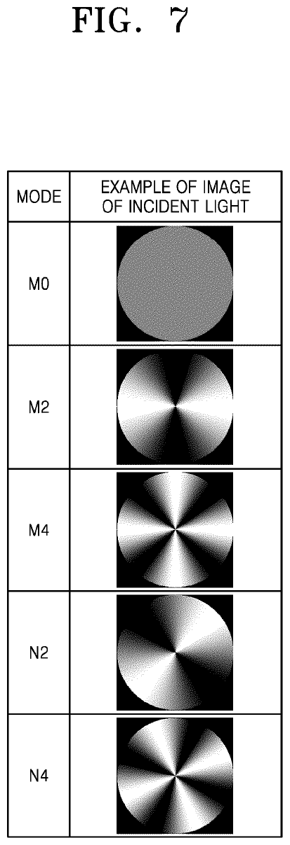

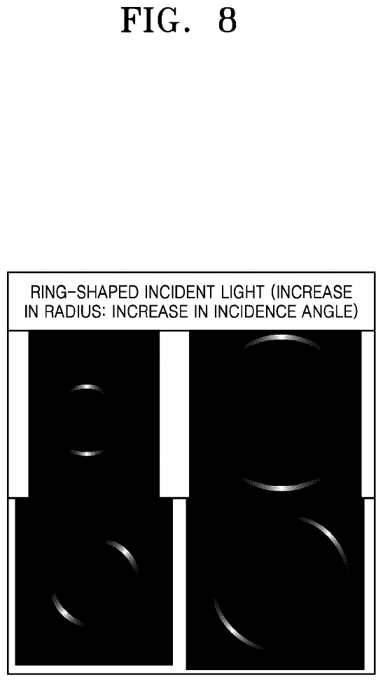

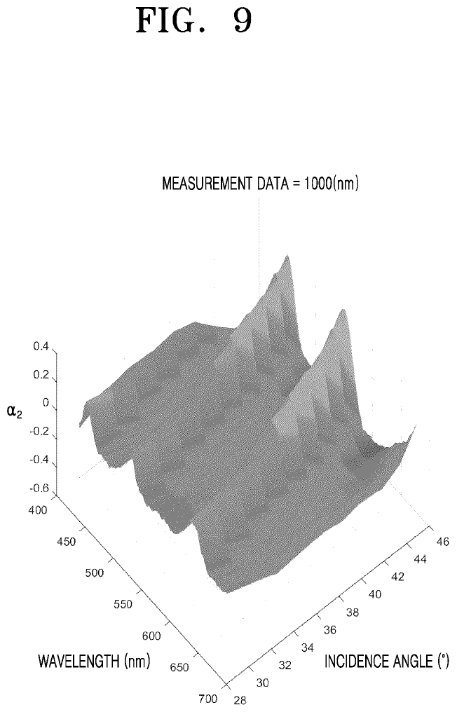

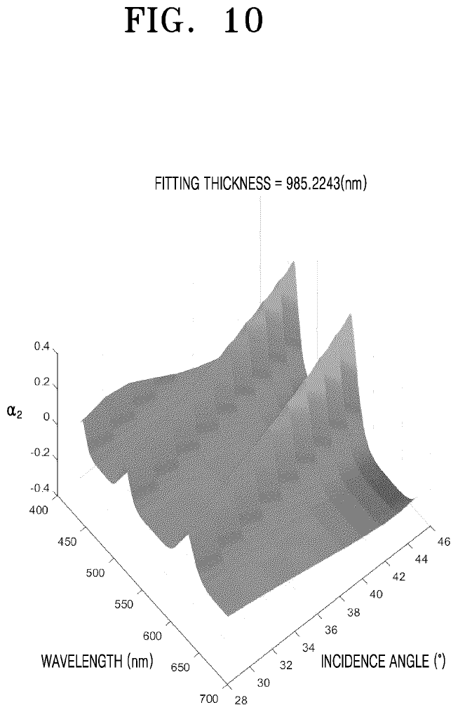

FIG. 1 is a conceptual diagram showing a basic structure of an ellipsometer according to the conventional art. FIG. 2 is a configuration diagram of an ellipsometer according to the present invention. FIGS. 3 and 4 are conceptual views illustrating characteristics of a back focal plane of an objective lens according to the present invention. FIGS. 5 and 6 are conceptual views illustrating a relationship between incident light incident on a sample and reflected light reflected from the sample according to the present invention. FIG. 7 is a view illustrating exemplary shapes of incident light according to the present invention. FIG. 8 is a view illustrating a shape in which the radius of incident light is changed according to the present invention. FIG. 9 is a graph showing an exemplary image of a measured polarization curved surface according to the present invention. FIG. 10 is a graph showing an exemplary image of a theoretical polarization curved surface according to the present invention.

### 1. Principles of the Ellipsometer (FIG. 1)

FIG. 1 is a conceptual diagram showing a basic structure of an ellipsometer according to the conventional art. A light source on the left serves to generate and emit incident light, and LEDs, lasers, and other various light sources with known intensity and wavelengths may be used as the light source.

The emitted incident light has a polarization state of a desired shape while passing through a polarization state generator (PSG). The PSG may include one or more various optical elements, for example, a polarizer, a compensator called as a retarder, a phase modulator, and the like. These optical elements and their roles are well known to those skilled in the art. Like the electrical elements, it is possible to adjust the incident light to have a desired polarization state (linear polarization, circular polarization, elliptical polarization) by combining such optical elements.

The incident light passing through the PSG is incident on a sample surface at a certain angle (θi). Incident light is divided into transmitted light that passes through the sample from the sample surface and reflected light that is reflected from the sample. Transmitted light is bent at a specific angle depending on the medium through which the incident light passed and the refractive index of the sample, and reflected light is reflected at the same angle (θr) as the incident light. That is, θi=θr. Here, a plane perpendicular to the sample, which is determined by incident light and reflected light, is referred to as a plane of incidence. Reflected light is in the form of an overlap of not only the light directly reflected from the sample surface, but also light that has passed through the surface of the sample at the top after the above-mentioned transmitted light travels inside the sample, is reflected from the surface of another medium placed at the bottom of the sample, and then passes through the sample surface at the top, or is reflected again from the sample surface and reflected downward and travels to the bottom, and then is reflected again from the surface of another medium at the bottom.

Since the reflected light has a different state from the incident light controlled by the PSG, it is possible to find out the state of the reflected light by placing a polarized state analyzer (PSA) on the path of the reflected light to analyze the state, for example, extracting only light of a specific polarization component and measuring its intensity or etc.

A photodetector at the end of the path of the reflected light measures the intensity of light and converts the measured intensity of light into an electrical signal. Photodetectors may be photodiodes, CCDs, etc., and generally do not measure the components or phase of light, but only measure intensity. However, only light in a specific polarization state may pass through by adjusting the polarization state analyzer, for example, by rotating the polarizer included in the polarization state analyzer, and even the polarization state of light may be calculated by detecting the intensity of light according to each polarization state. In addition, as shown below, the polarization state of light may be calculated by adjusting the incident light incident on the sample by rotating the polarizer contained in the polarization state generator instead of the polarization state analyzer.

Hereinafter, a change in the polarization state by the ellipsometer described above will be described using the Jones matrix. In this method, the state vector of light takes the form of a 1×2 matrix, and conventionally, the first row component of the matrix means p-polarized, that is, a transverse magnetic mode (TM mode) in which the oscillation direction of the magnetic field is perpendicular to the incident plane, and the second row component means s-polarized, that is, a transverse electric mode (TE mode) in which the oscillation direction of the electric field is perpendicular to the incident plane. The p-polarized and s-polarized components are perpendicular to each other. According to the notation of the Jones matrix, p-polarized light becomes

$$( \begin{matrix}1 \\ 0\end{matrix} )$$

and s-polarized light becomes

$$( \begin{matrix}0 \\ 1\end{matrix} ) ,$$

and the given light may be completely expressed by the intensity and phase of the p-polarized light and s-polarized light.

Meanwhile, the optical elements and the sample through which light passes on the optical path may be represented as a 2×2 matrix, and become an operator (a 2×2 matrix) that acts on the given light vector (a 1×2 matrix). For example, the polarizer becomes

$$( \begin{matrix}1 & 0 \\ 0 & 0\end{matrix} ) ,$$

the compensator becomes

$$( \begin{matrix}1 & 0 \\ 0 & {e}^{- i δ}\end{matrix} ) ,$$

and the sample becomes

$$( \begin{matrix}{r}_{p} & 0 \\ 0 & {r}_{s}\end{matrix} )$$

(assuming an isotropic material). In other words, the state of light transformed as it passes through an optical element or sample is compared to the action of the vector of light transformed by the operator. Since the polarization state generator or polarization state analyzer is a combination of optical elements represented by the 2×2 matrix, the whole may be expressed as a single 2×2 matrix by obtaining a product of a 2×2 matrix corresponding to the elements included therein.

Therefore, the result of light coming out of the light source, passing through the polarization state generator, sample, and polarization state analyzer, and entering the detector can be expressed as follows.

$$E = ( \begin{matrix}P & S & A\end{matrix} ) ( \begin{matrix}{r}_{p} & 0 \\ 0 & {r}_{s}\end{matrix} ) ( \begin{matrix}P & S & G\end{matrix} ) ( \begin{matrix}{E}_{0} \\ 0\end{matrix} )$$

Here, it is assumed that the light source (the rightmost vector) has only p-polarized light for convenience of explanation. In practice, when light is emitted from a light source, both the p-polarized component and the s-polarized component may be provided, but the polarization plate may be arranged in the introduction unit of the polarization state generator to convert the polarization component into a state vector having only a specific component.

Now, assuming the simplest form of polarization state generator and polarization state analyzer, the above equation is as follows.

$${}_{*} {E}^{-} ( \begin{matrix}1 & 0 \\ 0 & 0\end{matrix} ) ( \begin{matrix}cos A & - sin A \\ sin A & cos A\end{matrix} ) ( \begin{matrix}{r}_{p} & 0 \\ 0 & {r}_{s}\end{matrix} ) ( \begin{matrix}cos ( ω t - P ) & sin ( ω t - P ) \\ - sin ( ω t - P ) & cos ( ω t - P )\end{matrix} ) ( \begin{matrix}{E}_{0} \\ 0\end{matrix} )$$

Here, the vector on the rightmost side represents the light from the light source, the matrix on the left side represents the transformation by the polarization state generator (PSG), the matrix on the left side represents the sample, and the two matrices on the left side represents the transformation by the polarization state analyzer (PSA). In particular, the matrix on the leftmost side means that only light whose polarization direction matches the polarizer's angle (A) is passed based on the incident plane of the polarization state analyzer. In the above configuration, the polarization state generator and the polarization state analyzer are composed of only polarizers and function to leave only a linear polarization component corresponding to the polarizer's axis angle, and P and A are variables that mean the axial angles.

Since rp and rs contain information on the various properties of the material, the goal of ellipsometry is to find out the rp and rs values by adjusting the settings of the light source, polarization state generator, and polarization state analyzer.

Meanwhile, as described above, since only intensity is obtained from the photodetector, the function of the intensity (I (t)) is obtained as follows by multiplying the obtained E value and its complex conjugate (E*).

$$\vert {EE}^{*} \vert ∝ I ( t ) = {I}_{0} [ 1 + αcos2 ( ω t - P ) + βsin2 ( ω t - P ) ]$$

$${I}_{0} = \frac{1}{2} {\vert {r}_{s} \vert}^{2} {\vert {E}_{0} \vert}^{2} {cos}^{2} A ( {tan}^{2} ψ + {tan}^{2} A )$$

$$α = \frac{{tan}^{2} ψ - {tan}^{2} A}{{tan}^{2} ψ - {tan}^{2} A} , β = \frac{2 cos Δ tan ψ tan A}{{tan}^{2} ψ + {tan}^{2} A} \qquad \frac{{r}_{p}}{{r}_{s}} = tan ψ {e}^{i Δ}$$

$$Δ = {cos}^{- 1} \{ \frac{β}{\sqrt{1 - {α}^{2}}} \}$$

$$ψ = {tan}^{- 1} \{ \sqrt{\frac{1 + α}{1 - α}} tan A \}$$

In other words, by measuring the intensity I (t) through the adjustment of the optical system, the values of α and β may be found, the values of ψ and Δ may be found through the found values of α and β, and the values of rp and rs may be found through the found values of ψ and Δ. Once the rp and rs values are found, a consistency is determined by fitting the rp and rs values with the predicted values due to a physical model of a pre-made sample, and through a recursive process of adjusting the model itself or the variable values of the model accordingly, an appropriate (with a consistency greater than or equal to a predetermined reference value) physical model and the physical properties and characteristics of the sample may be calculated accordingly.

The consistency may be based on, for example, the variance of an error between a predicted value and an actual measured value, and those skilled in the art may set a criterion for measuring the consistency in various ways.

### 2. The Structure of an Ellipsometer According to an Embodiment of the Present Invention

Referring to FIG. 2, an angle-resolved spectroscopic ellipsometer 100 using a spatial light modulator according to the present invention includes a light source 110, a spatial light modulator 120, an incident light controller 125, a first relay lens 127, a polarizer 130, a first beam splitter 140, an objective lens 150, an analyzer 160, a second relay lens 165, a second beam splitter 170, a camera 180, a spectrometer 190, and a signal processing computer 195.

The light source 110 is a device that generates incident light. The light source 110 serves to generate and emit incident light. As the light source 110, various light sources having a known intensity and wavelength, such as a light emitting diode and a laser, may be used.

The spatial light modulator 120 is a device that spatially modulates light starting from the light source 110 to irradiate on a back focal plane of the objective lens 150. The spatial light modulator 120 may form an optical image having a specific shape. The spatial light modulator 120 may adopt, for example, a known digital micromirror device (DMD), a digital light projector (DRP), or the like.

The incident light controller 125 is a controller electrically connected to the spatial light modulator 120. The incident light controller 125 controls the amount of light emitted by the spatial light modulator 120 to have a specific function distribution. The incident light controller 125 controls the light irradiated by the spatial light modulator 120 to have a ring-shaped image. In addition, the incident light controller 125 controls the amount of light to have a sinusoidal-type distribution along the circumference of a ring. The incident light controller 125 may control, for example, the spatial light modulator 120 to have a ring-shaped incident light amount (lin) of

$$\frac{1}{2} + \frac{1}{2} sin ( 0 )$$

distribution. This case is defined as an MO mode. Meanwhile, the incident light controller 125 may control, for example, the spatial light modulator 120 to have a ring-shaped incident light amount (lin) of

$$\frac{1}{2} + \frac{1}{2} cos ( 2 φ )$$

distribution. This case is defined as an M2 mode. Meanwhile, the incident light controller 125 may control, for example, the spatial light modulator 120 to have a ring-shaped incident light amount (lin) of

$$\frac{1}{2} + \frac{1}{2} cos ( 4 φ )$$

distribution. This case is defined as an M4 mode. Meanwhile, the incident light controller 125 may control, for example, the spatial light modulator 120 to have a ring-shaped incident light amount (lin) of

$$\frac{1}{2} + \frac{1}{2} sin ( 2 φ )$$

distribution. This case is defined as an N2 mode. Meanwhile, the incident light controller 125 may control, for example, the spatial light modulator 120 to have a ring-shaped incident light amount (lin) of

$$\frac{1}{2} + \frac{1}{2} sin ( 4 φ )$$

distribution. This case is defined as an N4 mode.

The polarizer 130 is a device for polarizing light irradiated by the spatial light modulator 120. The polarizer 130 may be arranged in a fixed state. The polarizer 130 may employ a known polarizer.

The first relay lens 127 may be arranged between the spatial light modulator 120 and the polarizer 130. The first relay lens 127 is a lens device that adjusts the path of light of the spatial light modulator 120 to form an image at a specific position on a back focal plane of the objective lens 150 to be described later.

The first beam splitter 140 changes a direction of the light having passed through the polarizer 130. Light reflected from the sample 300 may pass through the first beam splitter 140. The first beam splitter 140 may employ a beam splitter having a known structure.

The objective lens 150 makes light incident from the first beam splitter 140 incident on the sample 300. The objective lens 150 is arranged on the same axis as the optical axis incident on the sample 300 and the optical axis reflected from the sample 300. A back focal plane of the objective lens 150 is formed between the first beam splitter 140 and the objective lens 150.

The analyzer 160 is arranged on the opposite side of the objective lens 150 with the first beam splitter 140 therebetween. The analyzer 160 serves to analyze the polarization of light reflected from the sample 300.

The camera 180 is a device for photographing an image of the back focal plane 200 of the objective lens 150 or the surface of the sample 300.

The spectrometer 190 is a device that receives a signal of light reflected from a specific region of the surface of the sample 300. The spectrometer 190 is installed to receive a signal of light reflected from a specific region of the surface of the sample 300 photographed by the camera 180. The spectrometer 190 may be installed to be two-dimensionally movable by a transfer device. The spectrometer 190 may include an optical fiber light receiving unit.

The second beam splitter 170 reflects some beams of the light reflected from the sample 300 to the spectrometer 190. The second beam splitter 170 serves to incident the rest beams of the light reflected from the sample 300 to the camera 180. The second beam splitter 170 may employ a beam splitter having a known structure.

The second relay lens 165 may be arranged between the analyzer 160 and the second beam splitter 170. The second relay lens 165 is a kind of zoom lens. The second relay lens 165 serves to assist the camera 180 to observe the image of the sample 300.

The signal processing computer 195 post-processes the signal received from the spectrometer 190 to calculate the physical properties of the thin film sample. The signal processing computer 195 may obtain a polarization factor of the sample 300 by performing simple arithmetic operation without Fourier transforming the signal received from the spectrometer 190. A method of obtaining the polarization factor will be described later. The signal processing computer 195 may form a measurement polarization curved surface having a polarization factor, a wavelength, and an incident angle component as three-dimensional coordinates using a signal received from the spectrometer 190. The thickness of the sample thin film may be obtained by comparing the similarity between the measured polarization curved surface and the calculated theoretical polarization curved surface. The signal processing computer 195 may also perform an operation of obtaining such a thin film thickness.

### 3. Principles of Operation of Ellipsometer in the Present Invention

### (1) The Behavior of Light in the Back Focal Plane (FIGS. 3 and 4)

FIGS. 3 and 4 are conceptual views illustrating characteristics of a back focal plane 200 of an objective lens 150 in the present invention.

FIG. 3 is a diagram for explaining that light incident at the same point on the back focal plane 200 is incident on the sample 300 at the same angle. The back focal plane 200, the objective lens 150 (simplified and displayed with a line for convenience of explanation), and the sample 300 of FIG. 2 are illustrated in FIG. 3. Three light paths are illustrated at points A and B on the optical path, and the solid lines from A and B pass through the left points on the back focal plane 200, the broken lines therefrom pass through the center points on the back focal plane 200, and the two-point dashed lines pass through the right points on the back focal plane 200. Although the starting points of the rays are different as A and B, each ray passing through the same point of the back focal plane 200 is incident to the sample 300 at the same angle through the objective lens 150. In other words, the rays (solid lines) passing through the left side of the back focal plane 200 at points A and B are incident at an angle of θ from the left when the rays are incident to the sample 300 through the objective lens 150, the rays (broken lines) passing through the middle of the back focal plane 200 are vertically incident on the sample 300 through the objective lens 150, and the rays (two-point dashed lines) passing through the right side of the back focal plane 200 are incident at an angle of θ from the right side when the rays are incident to the sample 300 through the objective lens 150.

In addition, the rays (solid lines) passing through the left side of the back focal plane 200 and the rays (two-point dashed lines) passing through the right side of the back focal plane 200 pass through the point equidistant from the central axis of the objective lens 150 on the back focal plane 200, and as a result, it may be seen that the angle of incident on the sample 300 is the same.

That is, the rays passing through the same point of the back focal plane 200 are incident to the sample 300 at the same angle, and this angle is determined by the distance from the central axis of the objective lens 150.

Meanwhile, FIG. 4 is intended to explain that even if light comes from different points on the sample 300, the light starting at the same angle meets at one point on the back focal plane 200. This principle may be seen by tracing the path of light rays in reverse in FIG. 3.

In FIG. 4, the sample 300, the objective lens 150 (simplified and displayed with a line for convenience of explanation), and the back focal plane 200 are illustrated. Light rays starting from different points A and B on sample 300 are raised to the left at the same angle (solid lines), are vertically raised (broken lines), or are raised to the right (two-point dashed lines), and the angle is the same even though the starting points of the sample 300 are different, and thus, the rays meet at the same point on the back focal plane 200, i.e., a, b, and c, respectively.

### (2) Adjustability According to the Position of the Incident Light on the Back Focal Plane in the Present Invention (FIGS. 5 and 6)

FIGS. 5 and 6 are conceptual views illustrating a relationship between incident light incident on a sample and reflected light reflected from the sample in the present invention;

First, the back focal plane 200, the objective lens 150, and the sample 300 are illustrated in FIG. 5. The sample 300 is located at a point away by the focal length f of the objective lens 150. Light rays (solid lines and broken lines) (only light rays vertically passing through the back focal plane 200 for convenience) that have passed through the back focal plane 200 pass through the objective lens 150 and are incident to the sample 300, and the following points may be seen.

First, when a ray is reflected after being incident, the angle of incidence and the angle of reflection are the same. (Obviousness in the principles of optics)

Second, the light rays beam passing through the same point on the back focal plane 200 are incident on the sample 300 at the same angle, and the value of the incident angle is the same when the radius distance from the central axis of the objective lens 150 is the same, that is, in the case of broken lines on the left and right sides or solid lines on the left and right sides in FIG. 6.

Next, FIG. 6 is a conceptual diagram showing the correlation between incident light incident at each point on the back focal plane 200 and reflected light accordingly in the polar coordinate system centered on the central axis of the objective lens 150.

The incident light by the optical system according to an embodiment of the present invention has the same polarization before being incident to the objective lens 150 and the sample 300, for example, polarization in the x-axis direction in this example (solid lines).

However, since each incident light has a different direction of bending depending on the angle (φ) in the polar coordinate system centered on the central axis of the objective lens 150, the direction of the incident plane varies accordingly (the broken lines between \textcircled{1} and \textcircled{1}′, \textcircled{2} and \textcircled{2}′, \textcircled{3} and \textcircled{3}′, and \textcircled{4} and \textcircled{4}′, respectively), and the components of p-polarized light and s-polarized light change, and as a result, the polarization components of the reflected light also change.

For example, the incident light \textcircled{1} is incident to the sample 300 through a path bent in the −x-axis direction while passing through the objective lens 150, and as a result, the incident plane (the broken line between \textcircled{1} and \textcircled{1}′) becomes parallel to the polarization direction, and the polarization of the reflected light comes out with the same polarization direction as the polarization direction of the incident light \textcircled{1}′). In addition, the incident light \textcircled{3} is incident to the sample 300 through a path bent in the −y-axis direction while passing through the objective lens 150, and as a result, the incident plane (the broken line between \textcircled{3} and \textcircled{3}′) becomes completely perpendicular to the polarization direction, and there is only s-polarized light, and thus, the reflected light comes out without being mixed with p-polarized components (regardless of phase change) \textcircled{3}′).

Meanwhile, in the case of incident light \textcircled{2} and \textcircled{4}, since the direction of bending (direction toward the center axis) while passing through the objective lens 150 is neither completely parallel nor completely perpendicular to the polarization direction, the incident light \textcircled{2} and \textcircled{4} have both p-polarized and s-polarized components, resulting in elliptical polarization of each of the reflected light \textcircled{2}′ and \textcircled{4}.

In other words, according to FIG. 6, even incident light with the same polarization changes the components of the p-polarized and s-polarized light according to the position on the back focal plane 200, to be precise, an angle (φ).

In summary, at a position on the back focal plane 200, an angle (φ) is adjusted with respect to the radius (r) and angle (φ) on the polar coordinate system with the central axis of the objective lens 150 as the origin. Accordingly, it is possible to adjust the components of p-polarized light and s-polarized light incident on the sample 300, and the incident angle (θ) incident on the sample 300 may be adjusted by adjusting the radius (r). However, in the present invention, incident light incident on the back focal plane 200 is configured in a ring shape and has a sinusoidal light amount distribution along the circumference of a ring. That is, it may be seen that light is incident on the back focal surface 200 in a state in which the polarization component according to the azimuth angle has already been adjusted.

### 4. Method of Measuring Physical Properties and Thin Film Thickness in the Present Invention

The method of measuring physical properties and thin film thickness according to the present invention uses the ellipsometer 100. The thin film thickness measurement method includes a sinusoidal beam incident operation, a beam projection operation, a reflected light signal acquisition operation, and a signal processing operation.

The sinusoidal beam incident operation is performed by collaboration between the incident light controller 125 and the spatial light modulator 120. In the sinusoidal beam incident operation, the spatial light modulator 120 modulates the light received from the light source 110 to have a ring-shaped image by the incident light controller 125. It is preferable that the width of the ring is formed as small as possible. In the sinusoidal beam incident operation, light having a sinusoidal light amount distribution is irradiated along the circumference of the ring. The intensity of light emitted in the sinusoidal beam incident operation may have a function

$$\frac{1}{2} + \frac{1}{2} sin ( 0 )$$

distribution. In this case, the light irradiated in the sinusoidal beam incident operation has the same amount of light along the ring shape. This case has been previously defined as the MO mode. As an example, circular light incident on the back focal plane 200 of the objective lens 150 in the MO mode is shown in FIG. 7.

Meanwhile, the intensity of light emitted in the sinusoidal beam incident operation may have a function

$$\frac{1}{2} + \frac{1}{2} cos ( 2 φ )$$

distribution. In this case, the light irradiated in the sinusoidal beam incident operation has a light amount distribution in the form of a sinusoidal along a ring shape. This case has been previously defined as the M2 mode. As an example, circular light incident on the back focal plane 200 of the objective lens 150 in the M2 mode is shown in FIG. 7.

Meanwhile, the intensity of light emitted in the sinusoidal beam incident operation may have a function

$$\frac{1}{2} + \frac{1}{2} cos ( 4 φ )$$

distribution. In this case, the light irradiated in the sinusoidal beam incident operation has a light amount distribution in the form of a sinusoidal along a ring shape. This case has been previously defined as the M4 mode. As an example, circular light incident on the back focal plane 200 of the objective lens 150 in the M4 mode is shown in FIG. 7.

Meanwhile, the intensity of light emitted in the sinusoidal beam incident operation may have a function

$$\frac{1}{2} + \frac{1}{2} sin ( 2 φ )$$

distribution. In this case, the light irradiated in the sinusoidal beam incident operation has a light amount distribution in the form of a sinusoidal along a ring shape. This case has been previously defined as the N2 mode. As an example, circular light incident on the back focal plane 200 of the objective lens 150 in the N2 mode is shown in FIG. 7.

Meanwhile, the intensity of light emitted in the sinusoidal beam incident operation may have a function

$$\frac{1}{2} + \frac{1}{2} sin ( 4 φ )$$

distribution. In this case, the light irradiated in the sinusoidal beam incident operation has a light amount distribution in the form of a sinusoidal along a ring shape. This case has been previously defined as the N4 mode. As an example, circular light incident on the back focal plane 200 of the objective lens 150 in the N4 mode is shown in FIG. 7.

In the beam projection operation, the light irradiated in the sinusoidal beam incident operation is polarized through the polarizer 130 and then projected onto the back focal plane 200 of the objective lens 150.

In the reflected light signal acquisition operation, the light projected by the beam projection operation is incident on the sample 300 through the objective lens 150. In the reflected light signal acquisition operation, the light reflected from a specific region of the sample 300 passes through the analyzer 160 and is detected as an electrical signal by the spectrometer 190. The signal detected by the spectrometer 190 is light reflected from a specific region of the sample 300. The spectrometer 190 may detect only light in a very small region, such as an optical fiber light receiving unit. In this embodiment, the spectrometer 190 may detect light in a very small region, with a diameter of about 1 μm of a specific region of the sample 300. Accordingly, light reflected from a fine circuit line width of 5 μm or less may be detected. As a result, there is an effect of dramatically improving the measurement resolution.

In general, the reflectance measured at one point of the back focal plane 200 of the objective lens 150 may be expressed by Equation (1).

$${I}_{BFP , out} = [ 1 , 0 , 0 , 0 ] {M}_{A} R ( - ( φ + \frac{π}{2} ) ) {M}_{M} {M}_{sample} R ( φ ) {M}_{p} [ \begin{matrix}{I}_{in} \\ 0 \\ 0 \\ 0\end{matrix} ] \qquad Equation ( 1 )$$

The Equation (1) may be simplified to Fourier coefficients for azimuth angles as shown in Equation (2) below.

$${I}_{BFP , out} = {I}_{in} ( DC + {α}_{2} cos ( 2 φ ) + {α}_{4} cos ( 4 φ ) + {β}_{2} sin ( 2 φ ) + {β}_{4} sin ( 4 φ ) ) \qquad Equation ( 2 )$$

However, the signal measured by the spectrometer 190 is not light incident at one point of the back focal plane 200, but light passing through a point having the same radius of the back focal plane 200 as a ring-shaped image. Accordingly, the signal measured by the spectrometer 190 is a signal in which the sum of light incident in a ring shape is reflected. Accordingly, the signal measured by the spectrometer 190 may be expressed as a reflectance in a specific region on the surface of the sample 300.

If the incident light incident on the sample 300 is in the M2 mode, the signal measured by the spectrometer 190 may be expressed in an integral equation as shown in Equation (3).

$${I}_{FFP , out} = {\int }_{0}^{{ρ}_{max}} {\int }_{0}^{2 π} {I}_{BFP , out} ρ d φ d ρ = {\int }_{0}^{{sin}^{- 1} ( NA )} {\int }_{0}^{2 π} {I}_{BFP , out} {R}^{2} sin ( θ ) cos ( θ ) d φ d θ = {R}^{2} {\int }_{0}^{{sin}^{- 1} ( NA )} sin ( θ ) cos ( θ ) {\int }_{0}^{2 π} {I}_{BFP , out} d φ d θ = \frac{{R}^{2}}{4} {\int }_{0}^{{sin}^{- 1} ( NA )} sin ( 2 θ ) {\int }_{0}^{2 π} ( 1 + cos ( 2 φ ) ) ( DC + {α}_{2} cos ( 2 φ ) + {α}_{4} cos ( 4 φ ) + {β}_{2} sin ( 2 φ ) + {β}_{4} sin ( 4 φ ) ) d φ d θ = \frac{{R}^{2}}{4} {\int }_{0}^{{sin}^{- 1} ( NA )} sin ( 2 θ ) ( 2 π DC + {πα}_{2} ) d θ \qquad Equation ( 3 )$$

In this way, when the incident light incident on the sample 300 is in the MO (M=0), M2 (M=2), M4 (M=4), N2 (N=2), and N4 (N=4) modes, the signal measured by the spectrometer 190 may be organized as follows.

$$\begin{matrix}M = 0 & = \frac{{R}^{2}}{4} {\int }_{0}^{{sin}^{- 1} ( NA )} sin ( 2 θ ) ( 2 π DC ) d θ \\ M = 2 & = \frac{{R}^{2}}{4} {\int }_{0}^{{sin}^{- 1} ( NA )} sin ( 2 θ ) ( 2 π DC + {πα}_{2} ) d θ \\ M = 4 & = \frac{{R}^{2}}{4} {\int }_{0}^{{sin}^{- 1} ( NA )} sin ( 2 θ ) ( 2 π DC + {πα}_{4} ) d θ \\ N = 2 & = \frac{{R}^{2}}{4} {\int }_{0}^{{sin}^{- 1} ( NA )} sin ( 2 θ ) ( 2 π DC + {πβ}_{2} ) d θ \\ N = 4 & = \frac{{R}^{2}}{4} {\int }_{0}^{{sin}^{- 1} ( NA )} sin ( 2 θ ) ( 2 π DC + {πβ}_{4} ) d θ\end{matrix}$$

In the above equations, the value on the left side is the value measured by the spectrometer 190. Therefore, the value of the left side becomes the measurement constant.

In the signal processing operation, the signal obtained in the reflected light signal acquisition operation is analyzed to calculate the physical properties of the thin film. In the signal processing operation, a polarization factor of the sample may be obtained by calculating the intensity of the reflected light measured by the spectrometer 190 under different incident light conditions.

Specifically, a value of α2 may be extracted through the arithmetic operation process of subtracting the MO mode from the M2 mode and dividing the subtracted result by the MO mode.

Likewise, if several arithmetic operations are performed using the difference between the measured values of the spectrometer 190 in modes such as M2, M4, N2, N4, etc., and the measured values of the spectrometer 190 in MO mode, values of α4, β2, and β4 may be extracted. The values of α2, α4, β2, and β4 are called polarization factors and are values widely used in practice. Since the polarization factor is closely related to the physical properties, knowing the polarization factor makes it easy to know the physical properties of the sample in reality.

In particular, a method of measuring the thickness among the physical properties of the sample will be described in more detail.

The incident light controller 125 may change the incident angle of light incident onto the sample 300 by changing the radius of the ring-shaped image.

The thickness of the thin film may be obtained by changing the incident angle in the incident light controller 125, forming a three-dimensional measurement polarized curved surface with a polarization factor, a wavelength value, and an incident angle, which are obtained in the signal processing operation, as orthogonal coordinates, and comparing the three-dimensional measurement polarized curved surface with a three-dimensional theoretical polarized curved surface formed by calculation.

More specifically, as ring-shaped sinusoidal incident light is projected onto the back focal plane 200 of the objective lens 150, the polarization factor, wavelength, and angle of incidence may be obtained. Now, as shown in FIG. 8, when the radius of the ring-shaped sinusoidal incident light is changed, the incident angle changes. When the signal of the spectrometer 190 is measured by the incident light controller 125 while changing the radius of the incident light, a three-dimensional measurement polarization curved surface consisting of a polarizing factor, a wavelength, and an incident angle may be configured as shown in FIG. 9. The thickness of the sample having the highest similarity may be obtained by the signal processing computer 195 by comparing the measured polarization curved surface illustrated in FIG. 9 with the calculated 3D theoretical polarization curved surface illustrated in FIG. 10.

As described above, in the angle-resolved spectroscopic ellipsometer and the thin film thickness measurement method using a spatial light modulator according to the present invention, the incident light projected on the back focal plane of the objective lens is configured in a ring shape with a sinusoidal-shaped light amount distribution. Accordingly, since there is no need to separately obtain signals according to changes in the azimuth, the measurement time for determining the polarization factor and thickness of the sample is dramatically shortened compared to conventional optical systems. For example, while the measurement time using a conventional ellipsometer takes 200 to 300 seconds, according to the present invention, the measurement time is about 10 seconds, making it possible to measure at least 20 to 30 times faster.

Here, only an ellipsometer polarizer according to a preferred embodiment of the present invention and a method of measuring physical properties using the same have been described, but those skilled in the art may implement various application methods using the present invention, which are all included in the scope of the present invention.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the disclosure as defined by the following claims.

What is claimed is:

1. An angle-resolved spectroscopic ellipsometer using a spatial light modulator, the angle-resolved spectroscopic ellipsometer comprising:
the spatial light modulator spatially modulating light originating from a light source to be irradiated to a back focal plane of an objective lens;
an incident light controller controlling the light emitted from the spatial light modulator to form a ring-shaped image and controlling the amount of light to have a sinusoidal distribution along the circumference of a ring;
a polarizer polarizing the light emitted from the spatial light modulator;
a first beam splitter changing the direction of the light passing through the polarizer and through which the light reflected from the sample passes;
the objective lens allowing the light incident from the first beam splitter to be incident on the sample;
an analyzer analyzing the polarization of the light reflected from the sample;
a camera capturing an image of the back focal plane of the objective lens or of a surface of the sample;
a spectrometer receiving a signal of light reflected from a specific region of the surface of the sample;
a second beam splitter reflecting a part of the light reflected from the sample to the spectrometer, and allowing the rest of the light to be incident on the camera; and a signal processing computer calculating a physical property value of a thin film by post-processing the signal received by the spectrometer.

2. The angle-resolved spectroscopic ellipsometer of claim 1, further comprising a first relay lens arranged between the spatial light modulator and the polarizer and adjusting a path of light of the spatial light modulator to form an image at a specific position on the back focal plane of the objective lens.

3. The angle-resolved spectroscopic ellipsometer of claim 1, further comprising a second relay lens arranged between the analyzer and the second beam splitter and assisting the camera to observe the image of the sample.

4. The angle-resolved spectroscopic ellipsometer of claim 1, wherein the spectrometer includes an optical fiber light receiving unit, and the spectrometer is able to be two-dimensionally moved by a transfer device.

5. A method of measuring the thickness of a thin film using the angle-resolved spectroscopic ellipsometer using a spatial light modulator, according to claim 1, the method comprising:
a sinusoidal beam incident operation in which the spatial light modulator, by the incident light controller, irradiates light received from a light source into light forming a ring-shaped image and having a sinusoidal distribution of the amount of light along the circumference of the ring-shaped image;
a beam projection operation in which the light irradiated in the sinusoidal beam incident operation is polarized through the polarizer and then projected onto a back focal plane of the objective lens;
a reflected light signal acquisition operation in which the light projected in the beam projection operation is reflected from a specific region of a sample by the objective lens, passes through the analyzer, and is detected as an electrical signal by the spectrometer; and
a signal processing operation of calculating physical properties of a thin film by analyzing the signal acquired in the reflected light signal acquisition operation.

6. The method of measuring the thickness of a thin film of claim 5, wherein the intensity of light emitted in the sinusoidal beam incident operation has a function
$$\frac{1}{2} + \frac{1}{2} sin ( 0 )$$
distribution.

7. The method of measuring the thickness of a thin film of claim 5, wherein the intensity of light emitted in the sinusoidal beam incident operation has a function
$$\frac{1}{2} + \frac{1}{2} cos ( 2 φ )$$
distribution.

8. The method of measuring the thickness of a thin film of claim 5, wherein the intensity of light emitted in the sinusoidal beam incident operation has a function
$$\frac{1}{2} + \frac{1}{2} cos ( 4 φ )$$
distribution.

9. The method of measuring the thickness of a thin film of claim 5, wherein the intensity of light emitted in the sinusoidal beam incident operation has a function
$$\frac{1}{2} + \frac{1}{2} sin ( 2 φ )$$
distribution.

10. The method of measuring the thickness of a thin film of claim 5, wherein the intensity of light emitted in the sinusoidal beam incident operation has a function
$$\frac{1}{2} + \frac{1}{2} sin ( 4 φ )$$
distribution.

11. The method of measuring the thickness of a thin film of claim 5, wherein, in the signal processing operation, a polarization factor of the sample is obtained by calculating the intensity of the reflected light measured by the spectrometer under different incident light conditions.

12. The method of measuring the thickness of a thin film of claim 5, wherein the incident light controller changes the incident angle of light incident onto the sample by changing the radius of the ring-shaped image.

13. The method of measuring the thickness of a thin film of claim 12, wherein the thickness of the thin film is obtained by changing the incident angle in the incident light controller, forming a three-dimensional measurement polarized curved surface with a polarization factor, a wavelength value, and an incident angle, which are obtained in the signal processing operation, as orthogonal coordinates, and comparing the three-dimensional measurement polarized curved surface with a three-dimensional theoretical polarized curved surface obtained by calculation.
